(19) United States
(12) Patent Application Publication
(10) Pub. No.: US 2024/0128585 A1
(43) Pub. Date: Apr. 18, 2024

(54) ELECTRONIC DEVICE

(71) Applicant: Panasonic Intellectual Property Management Co., Ltd., Osaka (JP)

(72) Inventors: Fuyuto NAKAMURA, Hyogo (JP); Tsunekazu IKATSU, Hyogo (JP); Ryota MORIKAWA, Osaka (JP); Keiichiro YOHARA, Osaka (JP)

(73) Assignee: Panasonic Intellectual Property Management Co., Ltd., Osaka (JP)

(21) Appl. No.: 18/396,116

(22) Filed: Dec. 26, 2023

Related U.S. Application Data
(63) Continuation of application No. PCT/JP2022/021055, filed on May 23, 2022.

(30) Foreign Application Priority Data
Jul. 13, 2021 (JP) 2021-115820

(51) Int. Cl. H01M 50/383; H01M 50/202; H01M 50/291; H01M 50/293

(52) U.S. Cl. CPC H01M 50/383; H01M 50/202; H01M 50/291; H01M 50/293; H01M 2220/30

(57) ABSTRACT

An electronic device of the present disclosure includes: a housing including a recess; a battery disposed inside the recess; and one or a plurality of flame extinguishing plates that are disposed in an opening of the recess and each include a plurality of through-holes allowing an inside and an outside of the recess to communicate with each other.

### 1. TECHNICAL FIELD

The present disclosure relates to an electronic device.

### 2. DESCRIPTION OF THE RELATED ART

Patent Literature (PTL) 1 discloses a portable electronic device equipped with a battery pack that releases a combustible gas to the outside by melting a closing member at a temperature in the battery pack raised by the combustible gas released from a battery cell.

PTL 1 is Unexamined Japanese Patent Publication No. 2008-226518.

### SUMMARY

The portable electronic device described in PTL 1 still has room for improvement in terms of improvement of safety.

The present disclosure provides an electronic device with improved safety.

An electronic device according to one aspect of the present disclosure includes: a housing including a recess; a battery disposed inside the recess; and one or a plurality of flame extinguishing plates that are disposed in an opening of the recess and each include a plurality of through-holes allowing an inside and an outside of the recess to communicate with each other.

According to the present disclosure, an electronic device with improved safety can be provided.

### BRIEF DESCRIPTION OF THE DRAWINGS

FIG. 1 is a perspective view of an example of an electronic device according to a first exemplary embodiment.

FIG. 2 is a view illustrating an undersurface of a body of the electronic device of FIG. 1.

FIG. 3 is an exploded perspective view of FIG. 2.

FIG. 4 is a view illustrating a state in which a lid of a housing is removed.

FIG. 5 is an exploded perspective view illustrating a battery.

FIG. 6 is a plan view illustrating a flame extinguishing plate.

FIG. 7 is a diagram for explaining a principle of flame extinguishment.

FIG. 8 is a schematic cross-sectional view illustrating a body of an electronic device according to Modification Example 1 of the first exemplary embodiment.

### DETAILED DESCRIPTION

(Background of Present Disclosure)

In an electronic device such as a notebook PC or a tablet PC, a rechargeable battery such as a lithium-ion battery is mounted. Repetitive charging and discharge of the rechargeable battery may result in deterioration of an electrolytic solution and generation of a gas. In this case, when excessive impact, heat, or the like is applied to the rechargeable battery, the generated gas may be ignited, and flames may come out from a housing of the electronic device.

The present inventors have studied a configuration in which flames can be safely extinguished even in the unlikely case where flames come out from a housing of an electronic device and have reached the following invention.

An electronic device according to a first aspect of the present disclosure includes: a housing including a recess; a battery disposed inside the recess; and one or a plurality of flame extinguishing plates that are disposed in an opening of the recess and each include a plurality of through-holes allowing an inside and an outside of the recess to communicate with each other.

According to this configuration as described above, an electronic device with improved safety can be provided.

In the electronic device according to a second aspect of the present disclosure, a gap may be formed between the battery and the one or plurality of flame extinguishing plates.

According to this configuration as described above, it is possible to prevent rupture of a housing caused by a gas released from the battery.

In the electronic device according to a third aspect of the present disclosure, the plurality of flame extinguishing plates may be disposed in an overlapping manner, and at least some of the plurality of through-holes formed in the plurality of flame extinguishing plates, respectively, may communicate with each other.

According to this configuration as described above, the safety can be further improved.

In the electronic device according to a fourth aspect of the present disclosure, a flow channel of a gas that is released from the battery and flows toward the flame extinguishing plate may be formed between a side wall of the recess and the battery.

According to this configuration as described above, the gas released from the battery can flow outside the housing, and it is possible to prevent rupture of the housing.

In an electronic device according to a fifth aspect of the present disclosure, the battery may include a pressure reducing valve provided on the flame extinguishing plate side.

According to this configuration as described above, it is possible to prevent rupture of the battery, and the gas released from the battery can flow outside the housing.

In the electronic device according to a sixth aspect of the present disclosure, each of the plurality of through-holes may have a size from 0.08 mm to 0.15 mm, inclusive.

According to this configuration as described above, the safety can be further improved.

In the electronic device according to a seventh aspect of the present disclosure, the plurality of through-holes may be arranged in a grid pattern.

According to this configuration as described above, the safety can be further improved.

In the electronic device according to an eighth aspect of the present disclosure, the flame extinguishing plate has a thickness of 0.5 mm to 1.0 mm, inclusive.

According to this configuration as described above, the safety can be further improved.

In the electronic device according to a ninth aspect of the present disclosure, the flame extinguishing plate may be made of metal.

According to this configuration as described above, the safety can be further improved.

Hereinafter, exemplary embodiments will be described with reference to the drawings.

### First Exemplary Embodiment

[Overall Configuration]

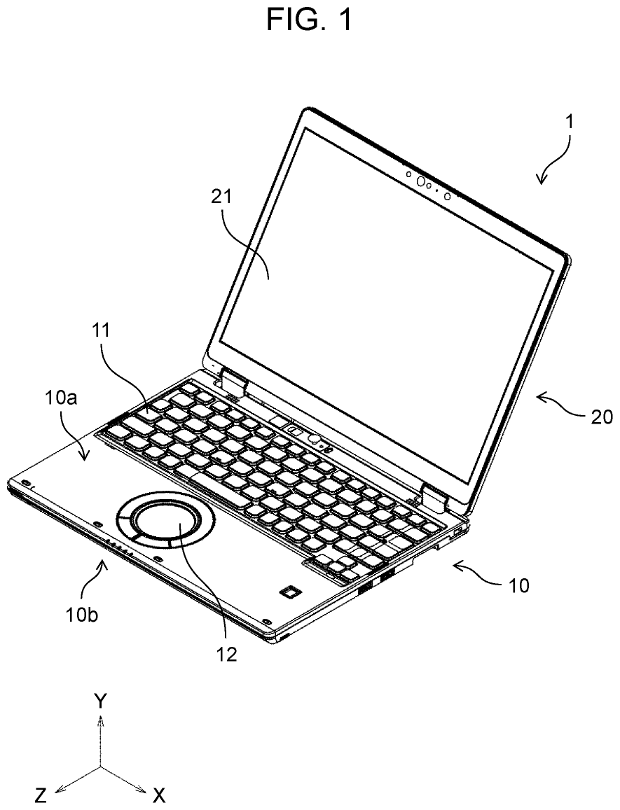

FIG. 1 is a perspective view of an example of electronic device 1 according to a first exemplary embodiment. Note that an X-Z-Y coordinate system illustrated in the drawings is provided to facilitate the understanding of the exemplary embodiments and is not intended to limit the scope of the exemplary embodiments in any way. In an X-Y-Z coordinate system, an X-axis direction corresponds to a width direction of the electronic device; a Y-axis direction corresponds to a depth direction of the electronic device; and a Z-axis direction corresponds to a thickness direction of the electronic device.

As illustrated in FIG. 1, electronic device 1 is a laptop personal computer. Electronic device 1 includes body 10 and display device 20 rotatably attached to body 10. Note that body 10 corresponds to a “housing” of the present disclosure.

Body 10 can include a CPU, a hard disk drive (HDD) or a solid state drive (SSD), various input and output devices, other components, and the like. Keyboard 11, touch pad 12, and the like are provided on upper surface 10a of body 10.

Display device 20 includes display unit 21. Display unit 21 is configured of, for example, a liquid crystal panel, an organic EL display, or the like.

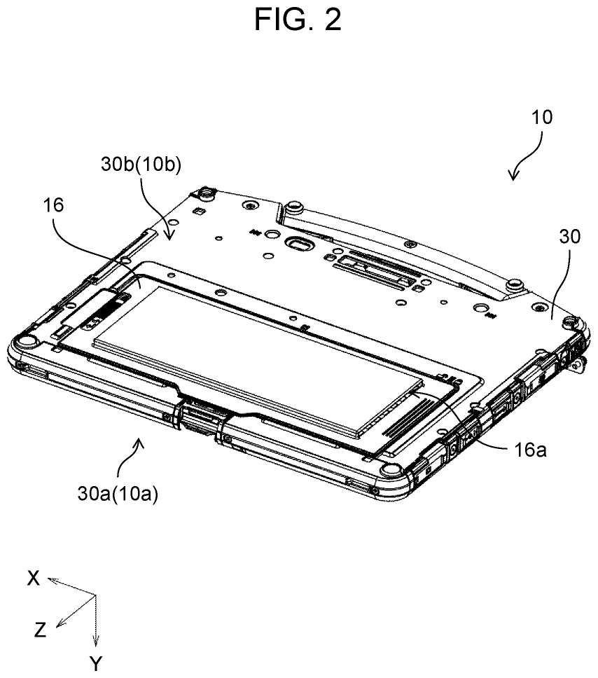

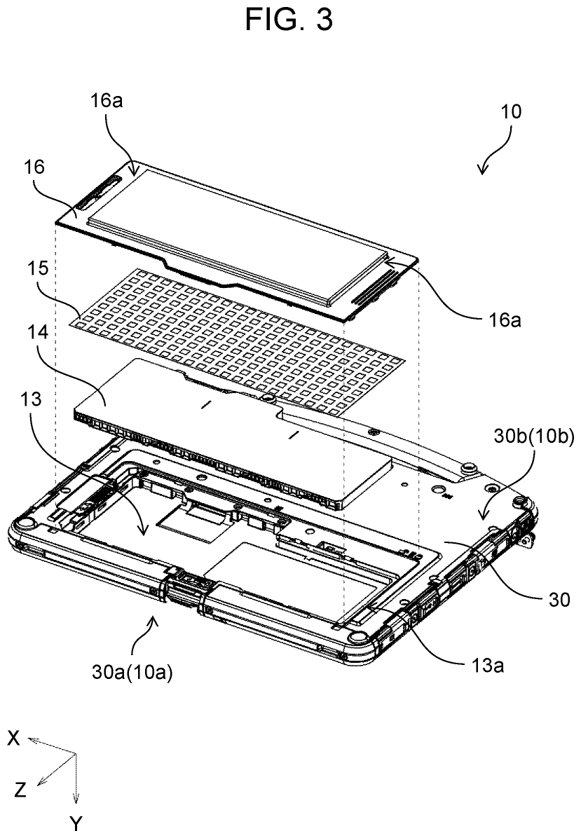

FIG. 2 is a view illustrating undersurface 10b of body 10 of electronic device 1 of FIG. 1. FIG. 3 is an exploded perspective view of FIG. 2. As illustrated in FIGS. 2 and 3, body 10 includes housing 30, battery 14, and flame extinguishing plate 15.

As illustrated in FIG. 3, recess 13 is formed in undersurface 30b of housing 30 (undersurface 10b of body 10), and battery 14 is disposed inside recess 13. Recess 13 is, for example, recessed from undersurface 30b toward upper surface 30a of housing 30. In the exemplary embodiment, recess 13 is formed in a rectangular shape. Opening 13a is formed in recess 13 on undersurface 30b side of housing 30. Opening 13a has, for example, a rectangular shape.

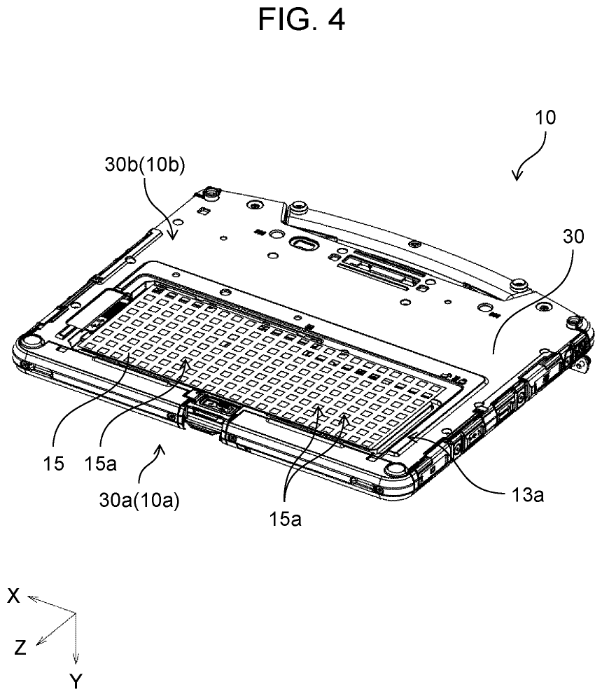

Battery 14 is, for example, a rechargeable battery such as a lithium-ion battery. Battery 14 will be described below in detail. Flame extinguishing plate 15 is disposed in opening 13a of recess 13 in which battery 14 is disposed (see FIG. 4), and opening 13a of recess 13 is closed by lid 16.

FIG. 4 is a view illustrating a state in which lid 16 of housing 30 is removed. As illustrated in FIG. 4, flame extinguishing plate 15 is disposed in opening 13a of recess 13 formed in body 10. Flame extinguishing plate 15 is a plate-shaped member made of metal, for example. Flame extinguishing plate 15 has a plurality of through-holes 15a allowing an inside and an outside of recess 13 to communicate with each other.

<Battery>

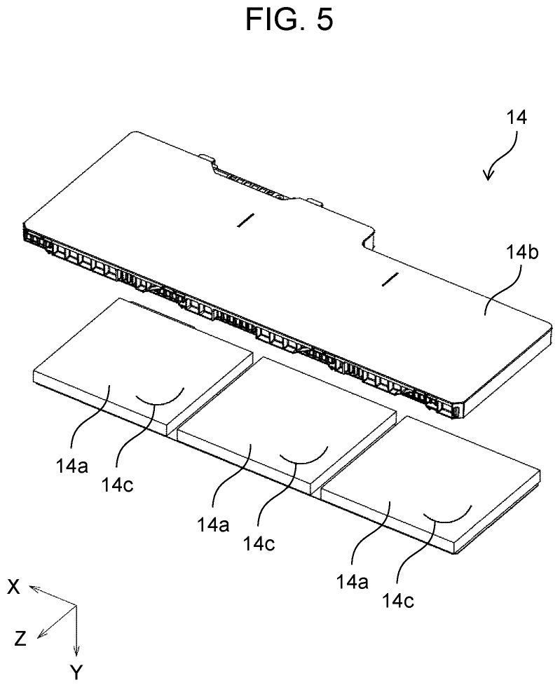

FIG. 5 is an exploded perspective view illustrating battery 14. As illustrated in FIG. 5, in the exemplary embodiment, battery 14 has a configuration in which three battery cells 14a are accommodated in battery case 14b.

As battery cell 14a, for example, a rechargeable battery that is repetitively charged and discharged, such as a lithium-ion battery, can be used. In battery cell 14a, repetitive charging and discharging result in deterioration of an electrolytic solution and generation of a high-temperature combustible gas. In order to allow the gas inside battery cell 14a to flow outside in a case where a pressure inside battery cell 14a exceeds a predetermined value, pressure reducing valve 14c is provided in battery cell 14a.

Battery case 14b is made of, for example, a PET resin or the like. Battery case 14b can be melted by heat of the gas released from pressure reducing valve 14c of battery cell 14a to release the gas from battery case 14b to the outside.

Pressure reducing valve 14c is provided on the side of battery cell 14a on which flame extinguishing plate 15 is disposed. Pressure reducing valve 14c can release the gas generated from battery cell 14a to the outside of battery cell 14a. In addition, since pressure reducing valve 14c is provided to be opened toward flame extinguishing plate 15, the gas released from pressure reducing valve 14c can be discharged to the outside from recess 13 of body 10 via flame extinguishing plate 15.

In rare cases, flames may be generated from battery 14 due to application of excessive impact, heat, or the like to battery 14, or due to ignition of a combustible gas generated from battery cell 14a, and thus flames may be generated from battery 14. Even in the unlikely case where flames are generated from battery 14, in the exemplary embodiment, flame extinguishing plate 15 is disposed in opening 13a of recess 13 for accommodating battery 14, and thus the flames can be extinguished when the flames are generated from battery 14.

<Flame Extinguishing Plate>

flame extinguishing plate 15 is disposed to cover opening 13a of recess 13 and is a member for extinguishing flames when the flames are generated from battery 14. Flame extinguishing plate 15 can be made of metal, for example. Considering that water enters the inside of recess 13, a rust-resistant metal material such as stainless steel may be selected for flame extinguishing plate 15.

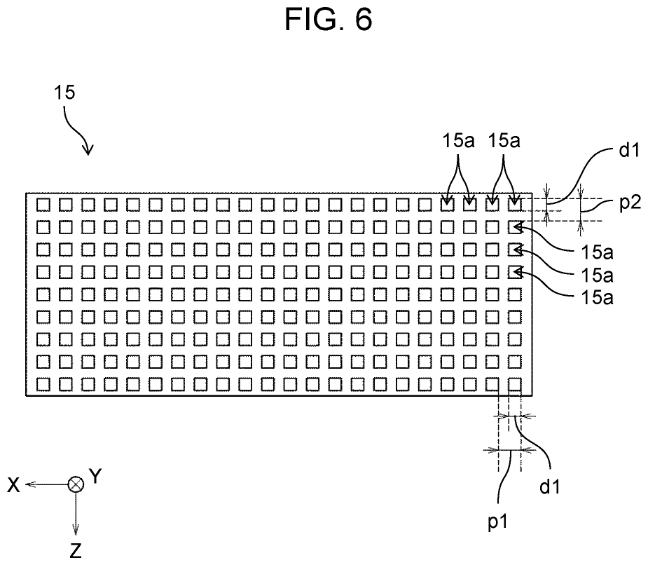

FIG. 6 is a plan view illustrating flame extinguishing plate 15. As illustrated in FIG. 6, a plurality of through-holes 15a are formed in flame extinguishing plate 15. The plurality of through-holes 15a allow the inside and the outside of recess 13 to communicate with each other. Therefore, the gas generated from battery 14 can be released to the outside of recess 13 by disposing flame extinguishing plate 15.

In the exemplary embodiment, as illustrated in FIG. 6, each of the plurality of through-holes 15a is formed in a square shape. Each of the plurality of through-holes 15a may be formed to have a size from 0.08 mm to 0.15 mm, inclusive, for example. The size of through-hole 15a means, for example, length dl of one side of through-hole 15a.

When the size of through-hole 15a is from 0.08 mm to 0.15 mm, inclusive, the flame extinguishing performance is enhanced, and the safety of electronic device 1 can be improved. On the other hand, when the size of through-hole 15a is larger than 0.15 mm, a flame extinguishing effect deteriorates. In addition, when the size of through-hole 15a is smaller than 0.08 mm, a gas generated from battery 14 is not efficiently allowed to flow to the outside of recess 13, and body 10 may be ruptured.

The shape of through-hole 15a is not limited to a quadrangle and may be a circle, an ellipse, or a polygon. In this case, the size of through-hole 15a can be a diameter of a circle, a major axis of an ellipse, or a length of a diagonal line of a polygon.

In addition, as illustrated in FIG. 6, pitches p1 and p2, which are intervals at which the plurality of through-holes 15a are arranged, are preferably from 0.1 mm to 0.25 mm, inclusive. By arranging the plurality of through-holes 15a at pitch p1 from 0.1 mm to 0.25 mm, inclusive, it is possible to more effectively extinguish the flames even in the unlikely case where flames are generated from battery 14. In the exemplary embodiment, pitch p1 in an X direction and pitch p2 in a Z direction have the same size. Note that pitch p1 and pitch p2 may have different sizes from each other.

As flame extinguishing plate 15 in which through-holes 15a are formed, a 250-mesh metal mesh in which about 250 through-holes are formed per inch can be used. Alternatively, as flame extinguishing plate 15, a punching metal in which through-holes 15a are formed by punching may be used.

In addition, as illustrated in FIG. 6, the plurality of through-holes 15a may be arranged in a grid pattern. A grid pattern means that the plurality of through-holes 15a are regularly arranged at pitch p1 in the X direction and are regularly arranged at pitch p2 in the Z direction, for example. Alternatively, the grid pattern means that the plurality of through-holes 15a are arranged in a matrix shape or a square grid array. By arranging through-holes 15a in the grid pattern, more through-holes 15a can be provided in flame extinguishing plate 15, and the flame extinguishing performance can be improved.

A thickness of flame extinguishing plate 15 is preferably from 0.5 mm to 1.0 mm, inclusive, for example. When the thickness of flame extinguishing plate 15 is within a range from 0.5 mm to 1.0 mm, inclusive, it is possible to decrease electronic device 1 in size and improve the flame extinguishing effect in the unlikely case where flames are generated from battery 14. Consequently, it is possible to provide electronic device 1 that is small in size and high in safety. In a case where the thickness is less than 0.5 mm, the flame extinguishing effect may deteriorate. On the other hand, in a case where the thickness exceeds 1.0 mm, the size and the weight of body 10 increase, and the increase in size and weight hinders a decrease in size of electronic device 1.

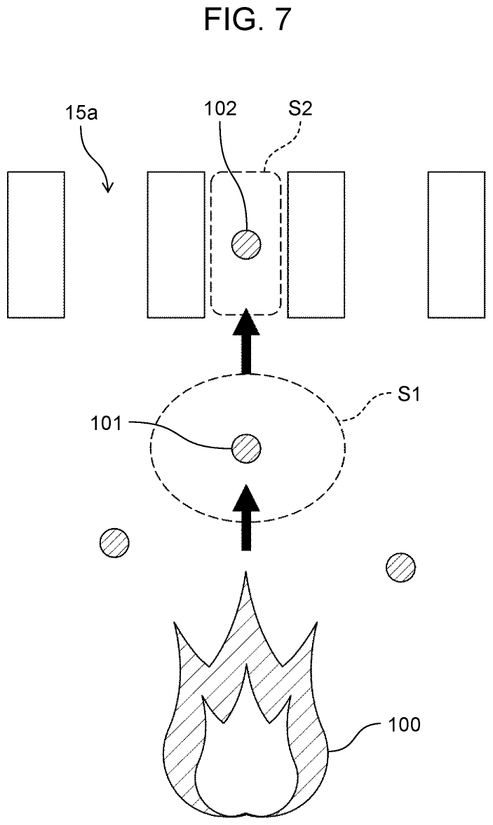

The flame extinguishment by flame extinguishing plate 15 will be described with reference to FIG. 7. FIG. 7 is a diagram for explaining a principle of flame extinguishment. In FIG. 7, molecules of fire spark 101 contained in flame 100 are free to move in space S1 having volume V1. Molecules of fire spark 102 that have entered through-hole 15a of flame extinguishing plate 15 can move freely in space S2 having volume V2 smaller than volume V1.

Here, when temperature T, pressure P, substance quantity n, volume V, and gas constant R are set, a state equation of PV=nRT is established. From the state equation of PV=nRT, a temperature of fire spark 101 decreases as a volume in which the molecules of fire spark 101 can freely move decreases. Temperature T2 of fire spark 102 having volume V2 that has entered through-hole 15a is lower than temperature T1 of fire spark 101 having volume V1 before fire spark 101 enters through-hole 15a. Here, volume V1 is larger than volume V2, and thus temperature T2 is lower than temperature T1. When temperature T2 of fire spark 102 is lower than temperature T1 of fire spark 101, the flames are extinguished. By the principle of such extinguishment, the flames can be extinguished by flame extinguishing plate 15.

By disposing flame extinguishing plate 15, even in a case where battery 14 is ignited, the flames are less likely to leak to the outside of body 10, so that the safety of a user can be improved. In addition, a flame extinguishing function can be fulfilled with a simple configuration in which flame extinguishing plate 15 is disposed.

<Lid>

Returning to FIGS. 2 and 3, lid 16 may be disposed in recess 13 of body 10 such that battery 14 and flame extinguishing plate 15 are not exposed. In the exemplary embodiment, lid 16 has vent hole 16a for allowing a gas generated in battery 14 to flow outside body 10. According to this configuration, since the gas generated in battery 14 passes through through-hole 15a of flame extinguishing plate 15 and is discharged outside body 10 from vent hole 16a of lid 16, it is possible to prevent body 10 from being ruptured by the gas.

[Effects]

According to the above-described exemplary embodiment, the electronic device with improved safety can be provided. Even in the unlikely case where battery 14 is ignited by an impact or heat on battery 14, the flames can be extinguished by flame extinguishing plate 15. Therefore, it is possible to provide electronic device 1 with high safety by suppressing the flames from leaking to the outside of body 10 of electronic device 1. In addition, since the flame extinguishing function can be fulfilled with the simple configuration in which flame extinguishing plate 15 is disposed, manufacturing costs can be reduced.

Note that, in the above-described exemplary embodiment, an example in which electronic device 1 is a laptop PC has been described, but various electronic devices such as a tablet PC and a smartphone can be employed as electronic device 1.

In addition, in the above-described exemplary embodiment, an example in which one flame extinguishing plate 15 is disposed has been described, but the number of flame extinguishing plates 15 is not limited to one. For example, the plurality of flame extinguishing plates 15 may be disposed in opening 13a of recess 13 in an overlapping manner. In this case, at least some of the plurality of through-holes 15a formed in the plurality of flame extinguishing plates 15, respectively, may communicate with each other. That is, in one example, the plurality of flame extinguishing plates 15 include a first flame extinguishing plate having a through-hole and a second flame extinguishing plate that is disposed to overlap the first flame extinguishing plate and has a through-hole. The through-hole of the first flame extinguishing plate communicates with the through-hole of the second flame extinguishing plate. Each of the first flame extinguishing plate and the second flame extinguishing plate may have a plurality of through-holes arranged in a grid pattern as illustrated in FIG. 6. By disposing the plurality of flame extinguishing plates 15, safety can be further improved. Since at least some of the plurality of through-holes 15a formed in flame extinguishing plates 15, respectively, communicate with each other, a gas generated in battery 14 can flow to the outside of recess 13, and rupture of body 10 can be prevented.

In addition, in the above-described exemplary embodiment, the configuration in which pressure reducing valve 14c is provided in battery cell 14a of battery 14 has been described, but the pressure reducing valve may be formed in battery case 14b. In this case, the pressure reducing valve may be formed on the side of battery case 14b on which flame extinguishing plate 15 is disposed.

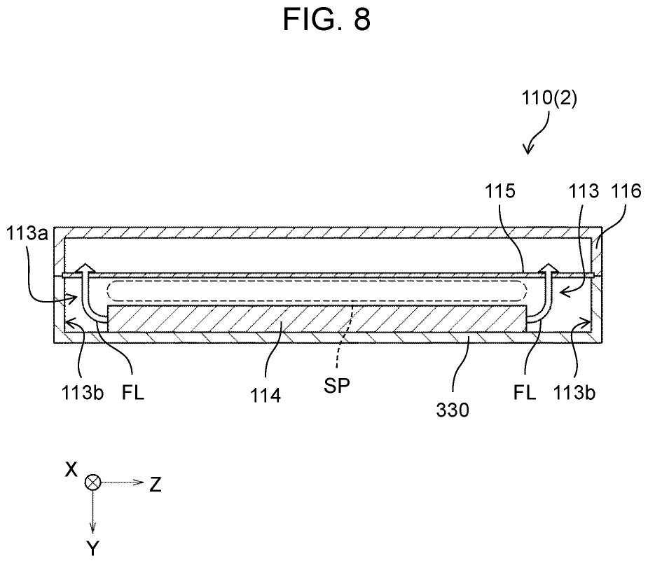

FIG. 8 is a schematic cross-sectional view illustrating body 110 of electronic device 2 according to Modification Example 1 of the first exemplary embodiment. As illustrated in FIG. 8, gap SP may be formed between battery 114 and flame extinguishing plate 115 in recess 113 formed in housing 330. Gap SP is formed between battery 114 and flame extinguishing plate 115, and thereby the pressure reducing valve of battery 14 is easily opened, in a case where a gas is generated from battery 14. Hence, the gas can be efficiently released.

In addition, as illustrated in FIG. 8, flow channel FL of a gas that is released from battery 114 and flows toward flame extinguishing plate 115 may be formed between side wall 113b of recess 113 and battery 114. By providing flow channel FL through which the gas flows, between side wall 113b of recess 113 and battery 114, the gas released from battery 114 can flow toward flame extinguishing plate 115. That is, flow channel FL is configured to allow the gas released from battery 114 to flow toward flame extinguishing plate 115. Therefore, body 110 can be prevented from being damaged.

In addition, since a gap is formed between lid 116 and flame extinguishing plate 115, rupture of electronic device 2 can be prevented.

The present disclosure can be applied to an electronic device such as a laptop PC, a tablet PC, or a smartphone.

What is claimed is:

1. An electronic device comprising:
a housing including a recess;
a battery disposed inside the recess; and
one or a plurality of flame extinguishing plates that are disposed in an opening of the recess and each include a plurality of through-holes allowing an inside and an outside of the recess to communicate with each other.

2. The electronic device according to claim 1, wherein a gap is formed between the battery and the one or plurality of flame extinguishing plates.

3. The electronic device according to claim 1, wherein
the plurality of flame extinguishing plates include
a first flame extinguishing plate having a through-hole, and
a second flame extinguishing plate that is disposed to overlap the first flame extinguishing plate and has a through-hole, and
the through-hole of the first flame extinguishing plate communicates with the through-hole of the second flame extinguishing plate.

4. The electronic device according to claim 1, further comprising a flow channel formed between a side wall of the recess and the battery,
wherein the flow channel is configured to allow a gas released from the battery to flow toward the one or plurality of flame extinguishing plates.

5. The electronic device according to claim 1, wherein the battery includes a pressure reducing valve configured to be opened toward the one or plurality of flame extinguishing plates.

6. The electronic device according to claim 1, wherein each of the plurality of through-holes has a size of from 0.08 mm to 0.15 mm, inclusive.

7. The electronic device according to claim 1, wherein the plurality of through-holes are arranged in a grid pattern.

8. The electronic device according to claim 1, wherein the one or plurality of flame extinguishing plates each have a thickness from 0.5 mm to 1.0 mm, inclusive.

9. The electronic device according to claim 1, wherein the one or plurality of flame extinguishing plates are made of metal.
